(19) United States
(12) Patent Application Publication
(10) Pub. No.: US 2011/0043365 A1
(43) Pub. Date: Feb. 24, 2011

(54) LIGHT-WEIGHT TRACK RECORDER OF A MOVING ANIMAL

(75) Inventor: Yi-Yang Li, Jhubei City (TW)

Correspondence Address: SCHMEISER, OLSEN & WATTS, 22 CENTURY HILL DRIVE, SUITE 302, LATHAM, NY, 12110, US

(73) Assignee: GTA ELECTRONICS CO., LTD., TAIPEI HSIEN (TW)

(21) Appl. No.: 12/546,153

(22) Filed: Aug. 24, 2009

(51) Int. Cl. G08B 23/00

(52) U.S. Cl. 340/573.1

(57) ABSTRACT

A light-weighted track recorder comprises a track body and track body further comprises a printed circuit antenna set, a processor, a memory, a battery and a substrate, wherein the processor is electrically connected to the printed circuit antenna set, and the processor activates the printed circuit antenna set to receive the satellite signals in accordance with a predetermined time limit, in which the received satellite signals are used by the processor to determine a coordinate point of the moving animal, and the determined coordinate point is then saved in the memory of the track recorder to determine a track record of the moving animal. The printed circuit antenna set and the battery are designed in such to reduce the total weight and size of the substrate of the track recorder.

### FIELD OF THE INVENTION

The present invention relates to a light-weighted track recorder and more particularly to a small and very light track recorder that is directly used on an animal for monitoring and recording GPS coordinates data of the movements and trails of the animal.

### BACKGROUND OF THE INVENTION

In recent years, our society has increasingly replied on the global position system (GPS) in our daily life, such as tracking a target's position. With the increasing demands of GPS system due to its popularity and success, various techniques have been developed to increase the utility and conveniences of the GPS applications in different areas. The popularity of GPS applications is due to its satellite-based navigation system that can continuously transmit data of satellite position information, timing and frequency to the potential users. The GPS signal contains timing information that allows a user to determine the time elapsed for the GPS signal to transverse the distance between the GPS satellite and a receiver receiving the signal. By knowing the time the GPS signal left GPS satellite, the time the GPS signal arrived at the user, and the speed of the GPS signal, the receiver can determine the distance from itself to the GPS satellite.

The GPS recorder can be used to record the trails and movements of the moving animals for study and research purposes. However, the recorder has to be attached to animal in order to determine the track record of animal. The size and the weight of the recorder become important as it has to be able to collect and record the movements and trails of the animal without affecting the movements of the animal or causing discomfort to the animal. A small and light-weighted recorder is required in such application.

The conventional GPS recorder comprises a GPS receiver, a processor, a memory and a battery, wherein the GPS receiver receives the satellite signals so that the processor can utilize the signal to calculate and determine the coordinates points of the animals' movements. The calculated coordinates data are then saved in the memory. The main problem of the conventional GPS recorder is that the ceramic chip antenna set in the recorder is about 25*25*4 mm³ in size, which is considerably large and resulting the substrate of the conventional GPS recorder is also big in size. The lightest recorder in the current market is about 6.2 g in total weight, which for some small animals, such birds, is still too heavy and too big to carry around. As a result, the GPS track recorders in the current market are not suitable for attaching to the moving animals, particularly small animals and birds.

### SUMMARY OF THE INVENTION

Therefore, it is a primary objective of the present invention to provide a small and light-weighted track recorder that is suitable to attach to a moving animal. It is another objective of the present invention to provide a track recorder that can determine the coordinates points of the moving animal and recording the track record of the animal. The light-weighted track recorder of the present invention is designed to monitor and record the movements and trails of a moving animal, wherein the track recorder comprises a track body and track body further comprises a printed circuit antenna set, a processor, a memory, a battery and a substrate, wherein the processor is electrically connected to the printed circuit antenna set, and the processor activates the printed circuit antenna set to receive the satellite signals in accordance with a predetermined time limit, in which the received satellite signals are used by the processor to determine a coordinate point of the moving animal, and the determined coordinate point is then saved in the memory of the track recorder to determine a track record of the moving animal. The printed circuit antenna set and the battery are designed in such to reduce the total weight and size of the substrate of the track recorder.

### BRIEF DESCRIPTION OF THE DRAWINGS

FIG. 1 is a schematic view of a small and light-weighted track recorder in accordance with a preferred embodiment of the present invention; and

FIG. 2 is a schematic view of a substrate of the light-weighted track recorder in accordance with the preferred embodiment of the present invention.

### DESCRIPTION OF THE PREFERRED EMBODIMENT

It is an object of the present invention to provide a simple, small and light-weighted track recorder for obtaining a track record of a moving animal. It is further object of the present invention to provide a track recorder that require low capacitance of battery without detriment to its function

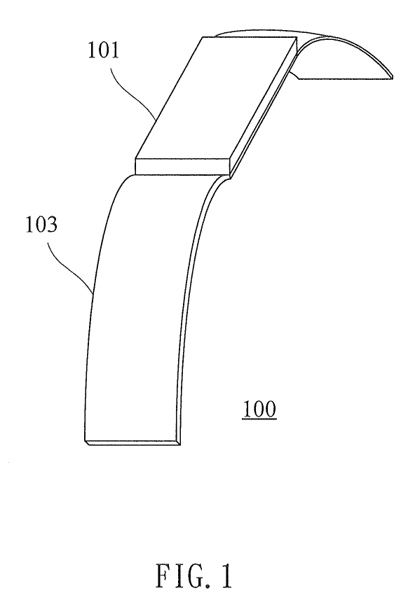

With reference to FIG. 1 for a schematic view of a simple and light-weighted track recorder in accordance with a preferred embodiment of the present invention, the small and light-weighted track recorder 100 is used to record and monitor the trails of a moving animal, wherein a fixed device 101 is used to position the light-weighted track recorder 100 onto the animal's body. The fixed device 101 can be a belt, a locking screw link or other locking gears that can attach the track recorder 100 onto the animal's body. The light-weighted track recorder of the present invention further comprises a track body 103 connected to the fixed device 101 of the track recorder 100, wherein the track body 103 of the track recorder 100 comprises data package for proceeding and recording the GPS coordinates data.

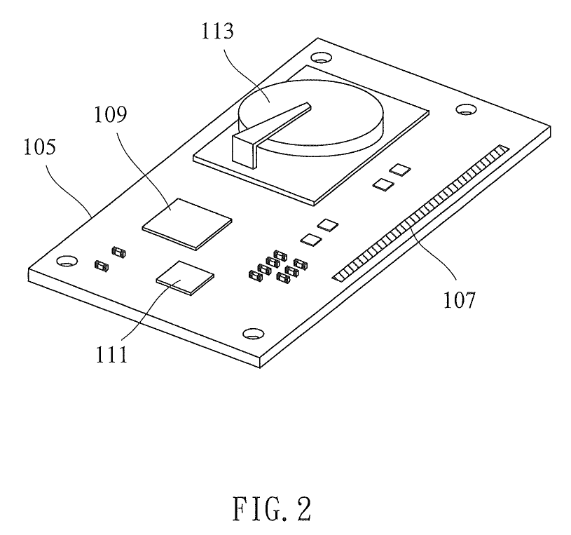

With reference to FIG. 2 for a schematic view of a substrate of the light-weighted track recorder in accordance with the preferred embodiment of the present invention. A substrate 105 is provided within the track body 103 of the track recorder 100 to act as a main circuit board, and a printed circuit antenna set 107, a processor 109, a memory 111 and a battery 113 are provided on the substrate 105. The substrate 105 is designed with the characteristics of light-weighted, small and compacted in such that it is installed in the small track recorder 100. In order to provide a compacted and light-weighted track recorder 100, the weight of the antenna is drastically reduced by utilizing a printing or etching method to fabricate the antenna set on the substrate 105. As a result, the printing method is used to produce the small and light-weighted printed circuit antenna set 107 on the substrate 105. The printed circuit antenna set 107 shown in FIG. 2 which is a rectangular receiving mean is used to receive the GPS satellite signal of a moving animal. The received GPS satellite signal is then transmitted via a transmitting path on the substrate 105 to the processor 109. The processor 109 is electrically connected to the printed circuit antenna set 107 and the memory 111. The printed circuit antenna set 107 can be made of radiative materials of Microstrip Patch Antenna, such as copper foil.

The received GPS satellite signal is calculated in the processor 109 to determine the GPS coordinates points of the moving animal at a particular time period. The calculated coordinates are recorded and stored in the memory 111 of the track recorder 100 during or after collecting a plurality of GPS coordinates points. The essential part of present invention is to receive a lot of GPS coordinates data at a specific time period and utilize these calculated data in determining characteristic property and generating a track record for the moving animal.

The processor 109 can activate the printed circuit antenna set 107 for searching, receiving and collecting the GPS coordinates data in accordance with a pre-determined time limit. The pre-determined time limit can be a regular time intervals or irregular time intervals, is used as a reference point and the subsequent coordinates data points are collected and saved in the track recorder 100. The coordinate data of the moving animal can be collected and recorded either regularly or irregularly in accordance with the set time intervals. In other words, the printed circuit antenna set 107 can be activated or deactivated at a pre-determined time limit set by the user.

The design of pre-set time intervals/limits for collecting and recording the coordinate data of the moving animal is to eliminate wasting the large amount of energy on processing and collecting the unnecessary data. The battery 113 of the track recorder 100 is specifically designed for low-capacitance of battery so that the total weight of the track recorder 100 can be reduced and is suitable for attaching to the moving animal. The low-capacitance and light-weighted batteries, such as Maxell CR3032, Maxell CR1216, or much smaller batteries such as the flat-lithium batteries, can be used in the track recorder 100 of the present invention. If the time interval is preset at every 10-20 seconds to activate the printed circuit antenna set 107 for collecting the GPS coordinates points, and the track record of the moving animal is calculated and determined via the processor 109. For a 3V of flat-lithium battery, the track recorder 100 of the present invention can be operated and recorded continuously at the 10-20 second time interval for at least 2 days. Through the pre-set time intervals, the printed circuit antenna set 107 is activated to transmit the coordinates points of the moving animals via the processor 109. The common lithium battery in the market, such as the button-type of battery, 3 V or 1.5V, or other low capacitance lithium batteries, can be utilized in the track recorder of our invention. When a desired voltage is lower than the rated voltage set in the track recorder 100, an additional boosted circuit can be installed on the substrate 105. The battery 113 of the present invention can be custom-made to directly supply the rate voltage required by the track recorder 100. The essential part of the present invention is that the track recorder is designed not to be limited to one type of battery, any light-weight and small or low-capacitance batteries can all be utilized in the present invention.

The design of the printed circuit antenna set 107 in the present invention is aimed at reducing the weight and size of the track recorder 100 tremendously. Further, the battery used in the track recorder 100 is also light-weighted and small in size, which can reduce the total weight of the track recorder 100. For example, the substrate 105 of the present invention is reduced to a size of 28*13*3 mm³ by using the printed circuit antenna and 3V button-type lithium battery, and the total weight of the track recorder 100 of the present invention is decreased to about 1.0 g which is only ⅙ of the total weight of a conventional track recorder's substrate, i.e. 6.2 g. Therefore, the track recorder 100 is specific designed with light-weighted and small in size that is suitable attached to the moving animal.

While the invention has been described by means of specific embodiments, numerous modifications and variations could be made thereto by those skilled in the art without departing from the scope and spirit of the invention set forth in the claims.

What is claimed is:

1. A light-weighted track recorder for monitoring and recording movements and trails of a moving animal, comprising
a track body attached to the moving animal, wherein the body further comprises
a printed circuit antenna set for receiving satellite signals;
a processor electrically connected to the printed circuit antenna set, wherein the printed circuit antenna set is activated by the processor to receive the satellite signals in accordance with a predetermined time limit, the received satellite signals are used by the processor to determine a coordinate point of the moving animal;
a memory electrically connected to the processor for storing the coordinate point;
a battery for supply power for the track recorder; and
a substrate for carrying the printed circuit antenna set, the processor, the memory and the battery.

2. The track recorder of claim 1, wherein the battery is light-weighted lithium battery.

3. The track recorder of claim 1, wherein the predetermined time limit of the track recorder is set in regular time intervals to activate the printed circuit antenna set to receive and collect the satellite signals for the processor in order to determine the coordinate point of the moving animal.
